(19) United States
(12) Patent Application Publication
(10) Pub. No.: US 2007/0097862 A1
(43) Pub. Date: May 3, 2007

(54) Call admission controlling device and method for providing qos in high-speed portable network

(76) Inventors: Jung-Mo Moon, Seoul (KR); Mi-Young Yun, Daejeon-city (KR); Yeong-Jin Kim, Daejeon-city (KR); Jee-Hwan Ahn, Daejeon-city (KR)

Correspondence Address: DILWORTH & BARRESE, LLP, 333 EARLE OVINGTON BLVD., SUITE 702, UNIONDALE, NY, 11553, US

(21) Appl. No.: 10/579,579

(22) PCT Filed: Sep. 21, 2004
(86) PCT No.: PCT/KR04/02416

§ 371 Date: May 17, 2006

(30) Foreign Application Priority Data
Nov. 17, 2003 (KR) 10-2003-0081053

(51) Int. Cl. H04L 12/26; H04L 12/56

(52) U.S. Cl. 370/230; 370/395.21

(57) ABSTRACT

Disclosed is a call admission controlling device and method for providing QoS (quality of service) in the portable Internet. When a mobile terminal requests a guarantee of the corresponding QoS and a call admission, a packet access router calculates a bandwidth available for resource reservation according to mobility characteristics of a cell to which the mobile terminal belongs, and determines resource reserved states according to the mobility characteristics with adjacent cells based on the calculated bandwidth to thus control call admission in order to satisfy a handoff dropping probability of the corresponding cell and prevent disconnected calls when a handoff toward the adjacent cells occurs. As a result, the handoff dropping probability of cells is guaranteed, and the resources are utilized effectively.

### TECHNICAL FIELD

The present invention relates to a call admission controlling device and method in a high-speed portable network. More specifically, the present invention relates to a call admission controlling device and method for providing QoS (quality of service) in a portable network for providing seamless handoff and using optimal radio resources of cells.

### BACKGROUND ART

Most systems for providing Internet access services only provide best effort services. As various multimedia services have appeared, it is required to provide QoS on the Internet, and call admission control on network resources including radio resources is also needed so as to provide distinguishing QoS.

Also, call admission control in consideration of mobility is necessary, which must perform reservation of additional resources in consideration of handoff at adjacent cells so as to provide seamless connection services irrespective of movements of mobile subscribers in the respective cells of the HPi (high-speed portable Internet.)

The call admission control method in the mobile network checks whether adjacent cells have handover resources, and admits a call only when the adjacent cells have them. That is, resources for new calls and those for handoff calls are classified, and resources reserved in advance for handoff are allocated at the time of performing handoff, thereby providing seamless services.

As demands of the QoS including multimedia services on the Internet have increased, new functions of the Internet nodes which previously considered the best effort services have come to be required. The QoS includes guaranteeing the uniform quality from the time of establishing connection to the time of service termination.

The above description also applies to the mobile networks in the same manner, that is, seamless QoS is to be provided to a subscriber when they are moving. However, it is needed to reserve the same bandwidth of all the neighboring cells in consideration of handoff so as to provide the seamless connection service to all the subscribers, and accordingly, usage rates of resources are substantially worsened.

Therefore, a dropping probability on a predetermined amount of QoS is assumed in the mobile network, and resources for handoff are occupied to thus enhance the usage rates of resources. In this instance, the probability that the QoS may be worsened is referred to as a handoff dropping probability, and it is very important to guarantee the handoff dropping probability in the mobile network.

When the static allocation method for reserving the same bandwidth for all adjacent cells by considering the handoff is used so as to provide seamless quality in the case of the subscriber moving, the usage rates of resources are very much lowered when a constant QoS to the connection of the subscriber is provided in the mobile network. In consideration of this, a dropping probability of a specific QoS is assumed, resources for handoff are obtained, and the usage rates of resources are increased, and in this instance, the dropping probability of QoS is referred to as the handoff dropping probability.

Usage of the static allocation fails to reflect mobility characteristics which are movements between cells or between regions of the mobile network. Also, when the respective cells reserve additional resources for handoff, the handoff dropping probability is increased when the handoff resources are allocated at less than the generation rates of handoff, and the usage rates of resources are lowered when the allocation of handoff resources is reserved at greater than the generation rates of handoff.

### DISCLOSURE OF INVENTION

Technical Problem

It is an advantage of the present invention to guarantee the handoff dropping probability on a call which is currently serviced, and to effectively use network resources.

It is another advantage of the present invention to provide a call admission controlling device and method for providing QoS of a portable Internet so that the HPi may provide seamless and excellent QoS.

Technical Solution

In one aspect of the present invention, in a device for performing data communication with a mobile terminal through a wireless channel, and controlling call admission according to a request of QoS (quality of service) from a terminal provided in a cell which is a communication area, the device being coupled to the cell, a call admission controller for providing QoS in a portable network comprises: a QoS request receiver for receiving a request of QoS requested by the terminal; a mobility characteristic information unit for storing mobility characteristic information on the respective cells; an available bandwidth information unit for storing available bandwidth information on the respective cells; a handoff dropping probability bandwidth calculator for producing a bandwidth for satisfying handoff dropping probabilities required by the respective cells; a calculator, coupled to the mobility characteristic information unit, the available bandwidth information unit, and the handoff dropping probability bandwidth calculator, for generating a default bandwidth for satisfying the QoS required by the terminal so as to determine whether to control call admission, a first bandwidth following the mobility characteristic on the cell in which the terminal is provided, and a second bandwidth for reserving additional resources for the cell; a comparator for comparing the first bandwidth generated by the calculator with the handoff dropping probability bandwidth of the cell, and comparing the second bandwidth with an established bandwidth; and a call admission control signal output unit for determining whether to admit the call following the request of QoS provided from the terminal when the first bandwidth satisfies the handoff dropping probability bandwidth or the second bandwidth is less than or equal to the established bandwidth according to the comparison results.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 shows a block diagram of a subsystem for an HPi (high-speed portable Internet) according to a preferred embodiment of the present invention;

FIG. 2 shows a configuration block diagram of a PAR according to a preferred embodiment of the present invention;

FIG. 3 shows a schematic diagram of mobility characteristics per cell according to a preferred embodiment of the present invention; and

FIG. 4 shows a flowchart of a call admission controlling method for providing QoS of the HPi according to a preferred embodiment of the present invention.

### BEST MODE FOR CARRYING OUT THE INVENTION

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

In order to provide seamless excellent QoS in the mobile network, when a packet excess router admits a corresponding call at the time of receiving a new QoS, it is determined whether the cells which are currently serviced may receive the seamless QoS when they handoff to other adjacent cells, and the call is admitted according to determination results.

To determine the request of admission, each cell periodically measures an average handoff probability and an average stay probability on the serviced calls per service class, and uses the probabilities and the used bandwidth to find overload states of the cells.

The present invention periodically measures the handoff dropping probability on the cells, and when a cell is found to have a handoff dropping probability greater than the guaranteed handoff dropping probability, the corresponding cell reserves resources by a specific amount greater than the predicted amount of resources, thereby preventing generation of new calls and increasing success rates of calls that have undergone the handoff. Further, the present invention allows reserving additional resources in proportion to the handoff dropping probability until the handoff dropping probability on the cells may be reduced below the guaranteed handoff dropping probability.

Based on the above-described features, a configuration and an operation of a call admission controlling device for providing QoS of the portable Internet according to a preferred embodiment of the present invention will now be described.

FIG. 1 shows a block diagram of a subsystem for an HPi (high-speed portable Internet) according to a preferred embodiment of the present invention.

Referring to FIG. 1, the HPi coupled to a HA (home agent) 130 for IP mobility through the Internet 120 and an AAA (authentication, authorization, and accounting) server 140 for authenticating and billing users comprises a PAR (packet access router) 111 and an AP (access point) 112 in a DS (distributed system) 110 managed by the PAR 111, and the AP 112 performs data communication with a terminal 113 through a radio channel.

The PAR 111 has a hierarchical structure for managing a plurality of APs 112 in a centralized manner, controls wireless resource states of a plurality of cells, and controls call admission for providing seamless QoS.

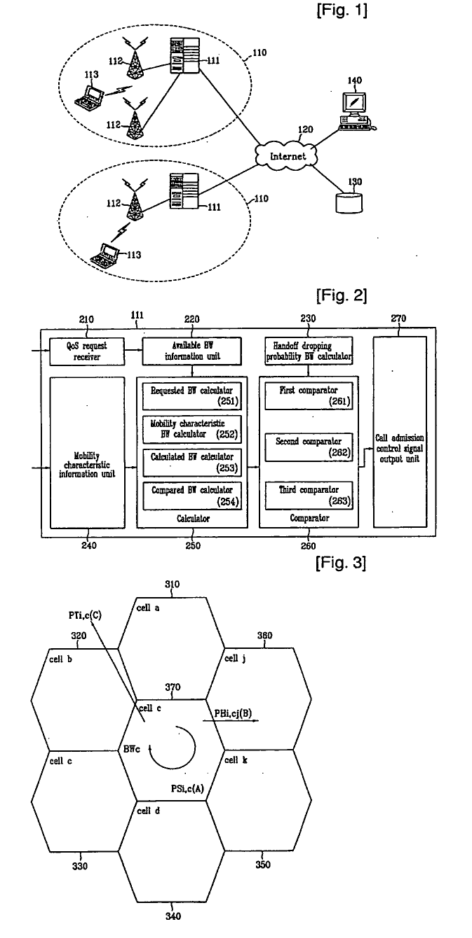

FIG. 2 shows a configuration block diagram of the PAR 111 according to a preferred embodiment of the present invention.

Referring to FIG. 2, the PAR 111 comprises a QoS request receiver 210, an available BW (bandwidth) information unit 220, a handoff dropping probability BW calculator 230, a mobility characteristic information unit 240, a calculator 250, a comparator 260, and a call admission control signal output unit 270.

The QoS request receiver 210 receives a QoS request from the terminal 113, and the available BW information unit 220 calculates available BW of the cell to which the corresponding terminal belongs.

The handoff dropping probability BW calculator 230 calculates a BW for satisfying the handoff dropping probabilities required by the respective cells, the mobility characteristic information unit 240 stores mobility characteristic information of respective cells coupled to the PAR 111, and the calculator 250 calculates a BW needed for call admission based on information provided by the available BW information unit 220, the handoff dropping probability BW calculator 230, and the mobility characteristic information unit 240.

The comparator 260 compares the BW calculated by the calculator 250 with the established BW. A first comparator 261 of the comparator 260 compares the available BW with a required BW, a second comparator 262 compares the measured handoff dropping probability with the required handoff dropping probability, and a third comparator 263 compares a calculated BW with a compared BW (a summation of available BW of the current cell and the BW used by the same service classes as that required by the terminal.)

The call admission control signal output unit 270 outputs admission or rejection on the receipt of the QoS request from the terminal 113 according to comparison results of the comparator 260.

A requested BW calculator 251 of the calculator 250 calculates a BW needed for the QoS request, a mobility characteristic BW calculator 252 calculates BW caused by the mobility characteristic of the cell to which the QoS request is provided, and a compared BW calculator 254 calculates a BW for comparison with a calculated BW calculator 253. Processes of calculating the respective BW by the calculators 251, 253, and 254 will now be described in detail.

Factors for showing the mobility characteristics used for controlling the QoS in the HPi are given as follows.

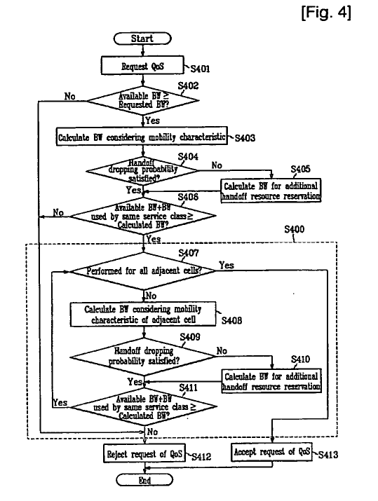

FIG. 3 shows a schematic diagram of mobility characteristics per cell according to a preferred embodiment of the present invention.

Referring to FIG. 3, the cells 310 to 370 respectively have a probability A for staying in the corresponding cell, a probability B for handing off to an adjacent cell, and a probability C for terminating access in the corresponding cell during a given time T per service class, and the cells respectively have a BW which is currently in use per class.

A call admission controlling method for providing the QoS of the HPi according to a preferred embodiment of the present invention will now be described.

FIG. 4 shows a flowchart of a call admission controlling method for providing QoS of the HPi according to a preferred embodiment of the present invention.

Since the PAR 111 only manages states of the cells in the lower hierarchy, the cell which is provided on the border of the PAR 111 can be provided near the cells in the lower hierarchy of the adjacent PAR. The PAR 111 which has a period of T so as to know status information of the cells in the lower hierarchy of the adjacent PAR, transmits status information including BW usage states of the cells in the lower hierarchy, and call generation rates on the QoS request to the adjacent PAR 111.

When the QoS request receiver 210 of the PAR 111 receives a QoS request from the terminal 113 which is accessed to the adjacent cell in step S401, the available BW information unit 220 checks an available BW which is usable in the cell to which the terminal 113 is currently accessed, the requested BW calculator 251 calculates a requested BW for providing a QoS desired by the terminal 113 in the previous step S401, and the first comparator 261 compares the available BW with the requested BW to check whether the available BW is greater than or equal to the requested BW in step S402.

In this instance, when receiving the QoS request from the terminal 113, the PAR 111 also receives QoS-related factors including a service class on the requested QoS, a maximum BW, an average BW, a minimum BW, and a maximum bucket size, and the minimum BW is used for the requested BW compared in the previous step S402, the requested BW being used for call admission control.

When the available BW is less than the requested BW according to the comparison result of S402, the call admission control signal output unit 270 rejects the QoS request in step S412 since it is difficult to provide a service which satisfies the requested QoS, and when the available BW is greater than or equal to the requested BW, the calculated BW calculator 253 calculates a BW according to the mobility characteristic of the corresponding cell in step S403 since it is possible to provide the service.

The calculated BW in consideration of the mobility characteristics including handoff of the corresponding cell is found as follows.

$$CalculatedBW = {BW}_{i , k} ⨯ {PS}_{i , k} + {\sum }_{j = 0}^{n} ( {BW}_{i , j} ⨯ {PH}_{i , jk} ) + {\sum }_{l = 0}^{m} ( ( {BW}_{i , l} + {λ}_{i , l} ⨯ T ) ⨯ {PH}_{i , lk} ) \qquad MathFigure 1$$

Equation 1 finds a calculated BW when a number of adjacent cells which belong to the k^{th} cell and the current PAR 111 is n, and a number of PARs 111 which have the k^{th} cell and the adjacent cells is m in the case that the terminal 113 requests a QoS of service class i.

BW_{i,k} is a summation of total BWs currently in use by the service classes i in the k^{th} cell, PS_{i,k} is a probability that the terminal 113 of service classes i in the k^{th} cell may stay within the given time T, PH_{i,jk} is a probability that the terminal 113 of service classes i in the j^{th} cell may move to the k^{th} cell within the given time T, and PH_{i,jk} is a handoff probability of from the PAR-L to the PAR to which the k^{th} cell belongs.

When the adjacent cell is not connected to the current PAR 111, BW_{i,l} is a bandwidth used by the service class i of the PAR-L in another adjacent PAR which is other than the PAR-L connected to the corresponding cell,

λ_{i,l}

is an average generation rate at the adjacent PAR 111 of the service class, T is a period for notifying the adjacent PAR of the load status from each PAR 111, and PH_{i,lk} is a handoff probability of from the PAR-L to the PAR 111 to which the k^{th} cell belongs.

The second comparator 252 determines whether the measured handoff dropping probability in the cell satisfy the handoff dropping probability required by the current cell in step S404, and the calculated BW calculator 253 finds a new calculated BW in step S405 based on the subsequent equation so as to reserve additional handoff resources when the calculated BW does not satisfy the handoff dropping probability required by the current cell.
NewCalculatedBW=CalculatedBW×(1+a) MathFigure 2

where “a” is a variable of a real number greater than zero and can be established by a user.

The third comparator 236 compares the new calculated BW found by Math FIG. 2 with a summation of the available BWs of the current cell and the BWs in current use by the service classes that correspond to the required service class (referred to as a compared BW hereinafter) in step S406.

When the new calculated BW is found to be greater than the compared BW, the call admission control signal output unit 270 rejects the corresponding QoS request in step S312, and when the new calculated BW is found to be less than the compared BW, the call admission control signal output unit 270 controls the respective units to perform the process of the dotted block 400 of FIG. 4 to all the adjacent cells.

That is, as shown in the block 400, the calculated BW in consideration of the respective mobility characteristics on the adjacent cells of the QoS requested cell is calculated based on Equation 1 in step S408, and it is determined whether the handoff dropping probability required by the corresponding adjacent cell is satisfied by using the calculated BW in step S409.

When the handoff dropping probability required by the corresponding adjacent cell is not satisfied by the calculated BW of the corresponding adjacent cell, a new calculated BW caused by Equation 2 is calculated in step S410, and the new calculated BW is compared with the compared BW of the corresponding adjacent cell.

When the new calculated BW is greater than the compared BW in any one of the adjacent cells of the cell which requested the QoS, the QoS request is rejected in step S412. In this instance, the process of the block 400 is performed by the PAR 111 shown in FIG. 2. However, when the calculated BW or the new calculated BW is less than the compared BW as to all the adjacent cells, the call admission control signal output unit 270 outputs a control signal for accepting the QoS request in step S413.

A reason for checking all the adjacent cells is to reduce the probability of failed calls handed off and provided in the adjacent cell by receiving a new current QoS.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

As described, the call admission controlling device and method for providing the QoS in the HPi measures the mobility characteristics including pause probabilities and handoff probabilities of the terminals in each cell at the time of QoS request in the HPi, and controls the call admission by using the measured results, thereby providing more effective resource usage, and guaranteeing the handoff dropping probability when a sudden handoff occurs.

Therefore, seamless excellent QoS is provided irrespective of a handoff caused by movement of the terminal.

1. In a method for performing call admission for a request of QoS (quality of service) from a cell which is a wireless channel communication area with a mobile terminal, a call admission controlling method for providing QoS in a portable network comprising:
(a) determining whether the cell has a bandwidth available to a request of QoS received from the terminal provided in a cell;
(b) calculating a first bandwidth for guaranteeing the QoS in consideration of a mobility characteristic of the cell when the cell has a bandwidth available to the request of QoS;
(c) calculating a second bandwidth for reserving additional resources when a handoff dropping probability required by calculation of the first bandwidth is not satisfied; and
(d) admitting the request of QoS of the terminal when the second bandwidth is less than or equal to a summation of the available bandwidth of the cell and a bandwidth used by the same service class as that of the requested service.

2. The call admission controlling method of claim 1, wherein the request of QoS received from the terminal in (a) includes a service class, a maximum bandwidth, an average bandwidth, a minimum bandwidth, and a maximum bucket size on the corresponding QoS.

3. The call admission controlling method of claim 1, wherein the step (a) comprises:
comparing the available bandwidth available by the cell and the bandwidth requested by the request of QoS by the terminal; and
determining that the corresponding cell has a bandwidth available to the request of QoS when the available bandwidth is found to be greater than the requested bandwidth.

4. The call admission controlling method of claim 1, wherein the step (b) further comprises: rejecting the request of QoS when the cell has no bandwidth available to the request of QoS.

5. The call admission controlling method of claim 1, wherein the first bandwidth in (b) is calculated by the subsequent equation:
$$FirstBW = {BW}_{i , k} ⨯ {PS}_{i , k} + {\sum }_{j = 0}^{n} ( {BW}_{i , j} ⨯ {PH}_{i , jk} ) + {\sum }_{l = 0}^{m} ( ( {BW}_{i , l} + {λ}_{i , l} ⨯ T ) ⨯ {PH}_{i , ik} )$$
where k is a cell which has requested the QoS, i is a service class, j is an adjacent cell, BW_{i,k} is a summation of total BWs currently in use by the service classes i in the k^{th} cell, PS_{i,k} is a probability that the terminal of service classes i in the k^{th} cell may stay within the given time T, PH_{i,jk} is a probability that the terminal of service classes i in the j^{th} cell may move to the k^{th} cell within the given time T, and PH_{i,jk} is a handoff probability of from the PAR-L to the PAR to which the k^{th} cell belongs.

6. The call admission controlling method of claim 1, wherein the second bandwidth in (c) is calculated by the subsequent equation:
SecondBW=FirstBW×(1+a)
where a is a variable of a real number greater than zero.

7. The call admission controlling method of claim 1, wherein the second bandwidth in (d) is less than or equal to a compared value, and
the steps of (a) to (d) are performed on all the adjacent cells of the cell, and the request of QoS by the terminal is admitted when the call admission is available to all the adjacent cells.

8. The call admission controlling method of claim 1, wherein it is determined in (d) with respect to all the adjacent cells of the cell that the cell is able to admit the request of QoS toward the adjacent cells when the steps of (a) to (d) are performed, the second bandwidth is calculated, and the second bandwidth of the corresponding adjacent cell is less than or equal to a compared value.

9. The call admission controlling method of claim 8, further comprising:
determining that admission on the request of QoS is impossible when the second bandwidth of the adjacent cell is greater than the summation of the available bandwidth of the corresponding adjacent cell and the bandwidth used by the same service class as that of the service from among the adjacent cells of the cell; and
terminating determination of whether to admit the request of QoS on residual adjacent cells, and rejecting the request of QoS from the terminal.

10. In a device for performing data communication with a mobile terminal through a wireless channel, and controlling call admission according to a request of QoS (quality of service) from a terminal provided in a cell which is a communication area, the device being coupled to the cell, a call admission controller for providing QoS in a portable network comprising:
a QoS request receiver for receiving a request of QoS requested by the terminal;
a mobility characteristic information unit for storing mobility characteristic information on the respective cells;
an available bandwidth information unit for storing available bandwidth information on the respective cells;
a handoff dropping probability bandwidth calculator for producing a bandwidth for satisfying handoff dropping probabilities required by the respective cells;
a calculator, coupled to the mobility characteristic information unit, the available bandwidth information unit, and the handoff dropping probability bandwidth calculator, for generating a default bandwidth for satisfying the QoS required by the terminal so as to determine whether to control call admission, a first bandwidth following the mobility characteristic on the cell in which the terminal is provided, and a second bandwidth for reserving additional resources for the cell;
a comparator for comparing the first bandwidth generated by the calculator with the handoff dropping probability bandwidth of the cell, and comparing the second bandwidth with an established bandwidth; and
a call admission control signal output unit for determining whether to admit the call following the request of QoS provided from the terminal when the first bandwidth satisfies the handoff dropping probability bandwidth or the second bandwidth is less than or equal to the established bandwidth according to the comparison results.

11. The call admission controller of claim 10, wherein the mobility characteristic comprises:
a service class for indicating a grade of the QoS desired by the mobile terminal in a communication area of an access point;
a maximum bandwidth, an average bandwidth, and a minimum bandwidth to be established for the service desired by the mobile terminal; and
maximum bucket size information needed for the service desired by the mobile terminal.

12. The call admission controller of claim 10, wherein the calculator calculates a default requirement bandwidth for satisfying the QoS required by the terminal, a first bandwidth following the mobility characteristic in the communication area of the access point, and a second bandwidth to be extracted by using the first bandwidth when the first bandwidth fails to satisfy the handoff dropping probability required by the communication area of the access point to which the terminal belongs.

13. The call admission controller of claim 10, wherein the comparator comprises:
a first comparator for comparing an available bandwidth of the cell with the default requirement bandwidth for satisfying the QoS required by the terminal;
a second comparator for determining whether the handoff dropping probability measured in the cell satisfies a required handoff dropping probability when the available bandwidth is greater than the default requirement bandwidth; and
a third comparator for comparing the established bandwidth with the second bandwidth established for reserving the additional resources extracted by using the first bandwidth when the first bandwidth fails to satisfy the handoff dropping probability required by the cell.

14. The call admission controller of claim 13, wherein the established bandwidth of the third comparator is a summation of the available bandwidth in the comcommunication area of the corresponding access point and the bandwidth used by the same service class as that of the service.

15. The call admission controller of claim 10, wherein the call admission control signal output unit admits the call which follows the request of QoS from the mobile terminal when the second bandwidth is less than or equal to the established bandwidth in the case that the first bandwidth fails to satisfy the handoff dropping probability.

16. The call admission controller of claim 10, wherein the call admission controller communicates with a second call admission controller for managing a second cell as well as the first cell managed by the call admission controller, and receives mobility characteristic information of the second cell.
